(19) United States
(12) Patent Application Publication
(10) Pub. No.: US 2015/0305389 A1
(43) Pub. Date: Oct. 29, 2015

(54) Small Particle Sized Protein Compositions And Methods Of Making

(71) Applicant: International Dehydrated Foods, Inc., Springfield, MO (US)

(72) Inventors: Roger Lynn Dake, Springfield, MO (US); Stephanie Lynch, Springfield, MO (US); Tobin Scot Powley, Nixa, MO (US)

(21) Appl. No.: 14/698,274

(22) Filed: Apr. 28, 2015

Related U.S. Application Data
(60) Provisional application No. 61/985,260, filed on Apr. 28, 2014.

(51) Int. Cl. A23L 1/315; A23L 1/308; A23L 2/66; A23J 3/00; A23J 1/02

(52) U.S. Cl. CPC A23L 1/3152; A23J 3/04; A23J 1/02; A23L 2/66; A23L 1/3085; A23V 2002/00

(57) ABSTRACT

This disclosure provides a high quality protein composition having small particle sizes and the processes of making the same. The compositions are shelf-stable, easy to use and have excellent nutritional values as compared to other protein products. The compositions may be prepared from animal sources, such as chickens or turkeys.

### RELATED APPLICATION

This application claims priority to U.S. Patent application 61/985,260 filed Apr. 28, 2014, the entire content of which is hereby incorporated by reference into this application.

### BACKGROUND

1. Field of the Invention

This disclosure relates to a process for preparing a high protein, small particle sized composition from animal meat or other animal parts. More particularly, the disclosure pertains to small particle sized protein compositions prepared from poultry and methods of making the same.

2. Description of Related Art

Protein is an essential nutrient for humans and animals. Traditional sources of proteins include, for example, animal meat (e.g., poultry, beef, pork, fish, etc.) that are complete in essential and indispensable amino acids; and various plants (e.g., soybean or pea) that are also rich in protein. Convenience foods such as bars, shakes, and smoothies are becoming more and more popular and have become important sources of protein intake. Other protein-rich products such as protein shakes, are used by athletes to maintain or grow muscle mass.

Protein powders are used extensively in making these convenience foods or specialty products. To date, most protein powders are obtained from plant sources, such as soy or pea. Other than protein powders prepared from milk, whey, or eggs, high-protein powders from other animal sources have not been reported or used in such protein-rich products. More particularly, high quality protein powders having small particle sizes that are derived from an animal meat have not been reported.

### SUMMARY

The disclosed instrumentalities advance the art by providing methods for preparing a high quality protein composition having small particle size from an animal source. Examples of animal sources may include but are not limited to meat or other body parts from birds, cattle, pigs, among others. Examples of birds may include but are not limited to chickens or turkeys.

The disclosed process improves upon existing processing steps in a unique way. In one embodiment, one or more enzymes may be used in the process of making the protein compositions. In another embodiment, a pressure cooking step may be employed in the disclosed process. It has been unexpectedly discovered that the disclosed process produces higher quality proteins by improving the amino acid composition and ratio extracted from normal raw materials. In one embodiment, the protein composition may contain more than 70%, 80%, 85%, or 90% (w/w) of protein but less than 12%, 10%, 8%, 5%, 3%, 2%, 1%, or 0.5% (w/w) of fat.

In another embodiment, the composition of this disclosure provides a high quality, complete animal protein powder from poultry that is insoluble but has small particle size. Small particle size is advantageous in preparation of special foods that must be administered through tube feeding, as well as many other applications.

In one aspect, the amino acid profile of the soluble proteins may be less desirable than the insoluble proteins. In another aspect, the disclosed composition contains insoluble protein whose quality is improved by removal of the soluble protein.

In another embodiment, the composition may be prepared from a starting material derived from an animal source. Examples of starting material may include but are not limited to meat, boneless meat or poultry trims from chickens or turkeys. In one aspect, the starting material may be processed (for example, through mechanical grinding) to generate a processed material in the form of fine particles or powders. In another aspect, in step (a), the starting material (processed or unprocessed) may be incubated with water at a temperature between 150-200 F to form a cooked material.

In another aspect, in step (b) the cooled material may be adjusted to a temperature between about 120° F. and 140° F. and one or more enzymes may be added and incubate for a time period between 1 and 6 hours, or between 1 and 3 hours, or about 2 hours. In another aspect, the one or more enzymes in this incubation step (b) may be a protease. In another aspect, the one or more enzymes in this incubation step (b) may have a working concentration in the range of 0.1%-0.5%, or about 0.2% by weight.

In another embodiment, the method may include a heating step (c) wherein the mixture from step (b) may be heated to a temperature effective in denaturing the enzyme for a sufficient period of time. The temperature effective in denaturing the enzyme depends on the nature of the enzyme. In one aspect, such denaturing process may be performed at a temperature at least 180° F. for at least five minutes to fully cook the mixture and denature the enzymes and form a cooked slurry. In another embodiment, the cooked slurry of step (c) may be further cooked (or incubated) at a temperature between about 200° F. and 300° F. under a pressure between 0 and 60 psig, or between 10 and 15 psig, for a time period between 15 minutes and 6 hours, or between 1 and 3 hours, to form a fully cooked slurry. In another embodiment, the fully cooked slurry of step (d) may be separated (for example, by centrifugation) into solid and liquid fractions, and the solid fraction may be collected as the desired protein composition. The obtained composition may be dried and processed into particle size of smaller than 1000, 500 or 100 microns. In one aspect, the liquid fraction may contain certain amount of the denatured enzyme. In another aspect, the majority of the denatured enzyme is in the solid fraction.

In one embodiment, no pH adjusting agent is added during the disclosed process to adjust the pH of the slurry or any intermediate products. In another embodiment, a pH adjusting agent may be added during the disclosed process to adjust the pH of the slurry or any intermediate products.

In another embodiment, the method may further contain an acidification step to reduce the pH of the protein composition obtained above. In another embodiment, the acidification step may include adding an acidic agent to the slurry obtained above or partially hydrolyzing the slurry, wherein the acidic agent is selected from the group consisting of carbonated water, carbon dioxide gas, and combination thereof. In one aspect, acid hydrolysis may help removing fat (lipid) from the composition. In another aspect, acid hydrolysis may facilitate selective fractionation of proteins and improve amino acid profiles, especially to increase the content of essential amino acids.

In another embodiment, the method may further contain a microfiltration step which selectively enriches one or more amino acids or one or more proteins in the composition obtained above. By way of example, the microfiltration step may be performed by passing the slurry through a membrane filter system designed to either remove or retain selected proteins and/or amino acids.

The protein composition thus obtained may be used in numerous products, such as, by way of example, protein drink, smoothies, or other nutritional beverages.

In another embodiment, the disclosed high protein, low fat compositions may contain high quality proteins comparable to those of egg proteins. In one aspect, the disclosed composition may have a Protein Efficiency Ratio (PER) score of greater than 60, 70, 80, 85, 90, 95 or 100 as compared to egg protein on PER tests performed on rats. In another aspect, the composition may contain amino acids having an amino acid profile that scores at least 80, 95, 98, or 99 Protein Digestibility Corrected Amino Acid Score (PDCAAS). In another aspect, the composition may contain amino acids having an amino acid profile that scores a perfect 100 Protein Digestibility Corrected Amino Acid Score (PDCAAS). In another aspect, the composition may contain essential amino acids having an amino acid profile that scores higher in a Digestible Indispensable Amino Acid Score (DIAAS) than regular broths prepared from chicken without using enzyme and/or without a pressure cooking step.

In another embodiment, the composition of the present disclosure may be used as a dietary supplement or may be used as a component of a dietary supplement. The supplement may serve various functionalities when administered to a living organism, such as a mammal, a fish, a bird or a domestic animal. These functionalities may include but are not limited to promoting growth of certain gut bacterium, maintaining a specific gut microbiome, enhancing immunoresponse, modulating inflammatory response of the mammal, or combination thereof. In one particular aspect, the disclosed composition may be used as a prebiotic that promotes gut microbiome or helps balance the different bacterial species in the gut of the organism. The term microbiome refers to the ecological community of commensal, symbiotic, and pathogenic microorganisms that share a body space within a mammal.

### DETAILED DESCRIPTION

This disclosure relates to a process for making a complete, high quality protein composition from an animal source, such as poultry (e.g., chicken or turkey). In one aspect, disclosed compositions have small particle sizes. Individual products that are made with very fine particle size are of special value because they can be used in significant amounts in liquid products such as shakes, protein sports drinks, and other beverages that require smooth texture and mouth feel.

In one embodiment, the disclosure provides methods of making a high quality protein composition from chicken. Chicken is widely consumed in numerous classic and creative applications as a healthy, nutritious food that is a great source of protein. In one aspect, this disclosure relates to a process to make a complete, high quality, low fat, and high protein concentrate from chicken that is available to food processors and consumers in a convenient form as a shelf stable powder. The disclosed protein composition is about the same protein percentage as soy and whey protein concentrates and isolates. The amino acid profile offered by this composition is well balanced and obtains the maximum score for Protein Digestibility Corrected Amino Acid Score (PDCAAS).

In one embodiment, the disclosed composition may be used by food processors and consumers in a convenient form, for example, as a shelf-stable powder.

Based on Protein Efficiency Ratio (PER) testing results, the protein composition disclosed herein is comparable to the highest quality proteins such as egg, and in many cases even exceeds the scores of whey and soy proteins. The PER score may be derived from growth weight of an animal fed a measured weight of food containing that protein as the only protein in the ration.

In another embodiment, with a complete, high quality protein source such as the composition of this disclosure, there is no need to mix multiple protein sources in order to provide a balanced protein source, and no amino acids need be specifically supplemented into the disclosed composition.

In another embodiment, the disclosed composition may provide an optimum balance of amino acids in a convenient form which is enhanced by its very small particle size. To date other insoluble chicken powders on the market have not been able to achieve the small particle size of the disclosed composition.

Table 1 shows the typical amino acid composition in total chicken meat protein (USDA SR-21 released Dec. 7, 2011 by U.S. Department of Agriculture).

TABLE 1
TYPICAL AMINO ACID COMPOSITION
OF MEAT PROTEIN FROM CHICKENS

| | Weight (mg) |
|---|---|
| Aspartic Acid | 3870 |
| Threonine | 1834 |
| Serine (w/w) | 1494 |
| Glutamic Acid | 6504 |
| Glycine | 2133 |
| Alanine | 2369 |
| Valine | 2155 |
| Methionine | 1203 |
| Isoleucine | 2293 |
| Leucine | 3259 |
| Tyrosine | 1466 |
| Phenylalanine | 1724 |
| Histidine | 1348 |
| Lysine | 3689 |
| Arginine | 2619 |
| Proline | 1785 |
| Hydroxyproline | ND |
| Cysteine | 556 |
| Tryptophan | 507 |
| Total | 43400 |

ND: Not Determined

Due to conditions such as kidney disease, some people must limit their dietary protein intake. For these people, proteins of the highest quality are optimum for sourcing and consumption. In one embodiment, the disclosed composition may be easier for kidneys to process than regular digested proteins.

In one aspect, the disclosed process may be used to turn lower value raw poultry materials into a high value protein powder without using additives. In another aspect, specific processing equipment may be used to achieve the specific result of very small particle size. By way of example, several representative steps of one of the embodiments of the disclosed processes are described below:

1. In one embodiment, raw chicken muscle such as boneless meat or trims may be used as the starting material. Alternatively, raw chicken frames and carcasses may be converted to mechanically separated chicken using equipment and techniques available in the art.

2. This material may be finely ground to allow optimum fractionation of protein from fat and other non-protein materials. Pieces of the starting raw material may be ground to an average size of less than 5 mm, 4 mm, 3 mm, 2 mm, or less than 1 mm.

3. The finely ground chicken may be cooked by any number of common processes known to the art, then followed by separation of liquid from solid fractions by screening, pressing, or passing through a centrifugal decanter as common in the art. The solid material is then milled to a fine texture, homogenized, and dried according to several available drying systems. By drying the product in a Tornado Windhex type dryer, the particle size is reduced more than standard drying systems and can attain a particle size less than 200 or 100 microns. If spray drying or other drying means are used, further milling in specialized equipment is needed, and perhaps is followed by screening and classifying by size to produce a product with average particle size less than 100 microns.

3. Another similar approach (see Example in this embodiment) to making a very small particle size product would be to provide very finely ground raw ground chicken from trims, whole boneless muscle, or mechanically separated chicken.

4. The finely ground raw material may be heated to at least 165° F. for at least 5 minutes to fully cook the product.

5. The cooked slurry may be passed through a centrifugal decanter or press to separate liquid from insoluble product.

6. The pressed or decanted meat would then be treated with enzymes to partially break down cross linked collagen bonds and thus open and loosen the fibrous structure of the cooked product. Up to three parts water might be added if necessary to provide a mixable, pumpable slurry for further processing steps. Enzyme treatment step time and temperature would be adjusted to meet optimum results, but a typical process would be two hours at 130° F.

7. The amount of enzyme would vary with individual enzymes chosen, but a typical example would be an amount of each enzyme used added at 0.1% to 0.3% of the solids weight.

8. After enzyme treatment, the slurry may be cooked to denature the enzymes. It also may be cooked in excess of the time and temperature needed to denature the enzymes to provide other desirable effects and attributes of the product. For examples, the cooking typically would be at least 185° F. for 5 minutes as a basic process, but might be cooked 2 or 3 hours or more at 15 psig (about 250° F.) for special outcomes.

9. The slurry can be decanted to remove the liquid fractions including fat, thus reducing the fat content of the finished product and increasing protein percentage.

10. The enzyme treated, re-cooked slurry may be finely milled before spray drying. Or, the slurry can be dried in a fluid bed dryer followed by milling to very fine particle size. Alternatively, the decanted product could be dried in a Tornado Windex type dryer to dry and pulverize to a very fine particle size simultaneously.

11. Extra milling, screening, and size classifying can be done at the end of the process to provide product particle size of specific ranges.

In another embodiment, an alternative process is described below:

The raw material may be finely ground to allow optimum fractionation of protein from fat and other non-protein materials. The finely ground chicken starting material may mixed with water to make a free flowing slurry. Protease enzyme(s) may be added to the mixture at an optimum percentage that depends on the enzymes used and the finished product desired. This mixture is heated to an optimum digesting temperature and allowed to react for an optimum time. Process times and temperatures are varied for best results, but an example would be a weight of enzyme equal to 0.2% of the protein content of the raw material, a temperature of 130° F., and a two hour reaction time.

After enzyme treatment, the mixture is heated to at least 180° F. for at least five minutes to fully cook the mixture and denature the enzymes. This initial cooking time and temperature may be varied to achieve desired results. In one process, the cooking time and temperature may be elevated to more than 230° F. to achieve more tenderness and help break down the structure of the product, so milling can more easily reduce particle size to the desired range.

The cooked slurry may be passed through a centrifugal decanter to separate into liquid and solid fractions. The separated fat is sent to other product uses, and the broth may be sent to other product uses or re-incorporated into the meat fraction.

The meat fraction, with or without the broth, may be finely milled and dried in standard dryers such as spray dryers or other appropriate dryers known in the art. Alternatively, the meat may be dried in a dryer such as a fluid bed dryer followed by finely milling; or, the cooked meat slurry may be dried in a type of dryer that dries and mills into a fine powder simultaneously, such as a Windhex Tornado Dryer.

The dried meat may or may not need to be further milled, screened, and or classified by particle size to provide very fine particle sizes as needed, as small as <100 microns.

The processing step combination of enzyme digestion and extended cooking of the finely ground product results in a high yield of protein that has higher quality than regular products made from animal sources, regardless of the materials or cooking process used. The combination of enzymatic and thermal processes extract and provide more essential amino acids than those extracted using existing processes.

In one embodiment, the protein compositions may be used as an ingredient in food or beverage products. In another embodiment, the composition obtained may be used in numerous applications as a wholesome, all natural ingredient. The disclosed extract may also be used to prepare protein drinks, smoothies, or other nutritional beverages.

It is to be noted that, as used in this specification and the claims, the singular forms “a,” “an,” and “the” include plural referents unless the context clearly dictates otherwise. Thus, for example, reference to “a device” may include reference to one device, as well as two or more devices, unless the context clearly limits the reference to one device.

The terms “between” and “at least” as used herein are inclusive. For example, a range of “between 5 and 10” means any amount equal to or greater than 5 but equal to or smaller than 10.

Unless otherwise specified, the percentage of certain component in a composition is by weight of total solid. Various commercially available products may have been described or used in this disclosure. It is to be recognized that these products are cited for purpose of illustration only. Certain physical and/or chemical properties and composition of the products may be modified without departing from the spirit of the present disclosure. One of ordinary skill in the art may appreciate that under certain circumstances, it may be more desirable or more convenient to alter the physical and/or chemical characteristics or composition of one or more of these products in order to achieve the same or similar objectives as taught by this disclosure.

### EXAMPLES

The following examples are provided to illustrate the present invention, but are not intended to be limiting. The reagents, materials and instruments are presented as typical components, and various substitutions or modifications may be made in view of the foregoing disclosure by one of skills in the art without departing from the principle and spirit of the present invention.

### Example 1

### Preparation of a Protein Composition Having Small Particle Size From Poultry

Raw mechanically separated chicken (MSC) was cooked (with water or steam) to 185° F. for about 5 to 55 minutes before being pumped through a centrifugal decanter which separated the liquid fractions from the insoluble fraction. The insoluble fraction was mixed with water at a ratio of about two parts water to one part chicken insolubles and the temperature of the mixture was adjusted to 130° F. Protease enzymes (e.g., Alcalase, flavorzyme, liquipanol, protamex, Protease FNP, alkaline protease L-660) were added at 0.2% (by weight) of the solids content of the chicken and the batch was well mixed. The batch was held for about two hours for the enzyme treatment to complete.

After the enzymatic digestion step, the batch was cooked at 240-250° F. (10-15 psig) for three hours which denatured the enzymes and further broke down the protein structure. The cooked slurry was then passed through a second decanter which removed the liquid fraction.

The cooked, decanted insoluble fraction was added to about equal parts water and was milled using a Silverson homogenizing mixer. The resultant finely milled slurry was dried and evaluated for mouth feel. The result was a very smooth texture that did not have undesirable gritty or sandy mouth feel.

### Example 2

### Preparation of a Protein Composition Having Small Particle Size From Poultry Without an Initial Cooking Step

Raw mechanically separated chicken (MSC) was placed into a vessel with two parts water to one part chicken solids. After thorough mixing, the mixture was separated into solid and liquid fractions using a centrifuge. The liquid fraction was discarded, and the meaty solid fraction was retained for further processing.

This solid fraction was mixed with about 3 parts water to one part solids to form a slurry. Two protease enzymes (Alcalase and flavorzyme) were added at 0.2 percent (by weight) of the solids and were thoroughly mixed into the slurry. The slurry-enzyme mixture was heated to 130° F. and incubated for 2 hours with intermittent agitation. After this incubation time, the mixture was cooked at 190° F. for 10 minutes to completely denature the enzymes. The mixture was then centrifuged at 3,600 rpm for 5 minutes to separate off the liquid fraction. The resultant cooked decanted slurry was dried and evaluated for texture, mouth feel etc. and was found to have a silky smooth, almost creamy mouth feel.

It is to be recognized that the disclosed composition differs from Mechanically Separated Chicken (MSC) at least in that the disclosed composition contains various high quality proteins extracted from MSC, with various low quality proteins from MSC removed.

We claim:

1. A composition prepared from a starting material derived from an animal source, said composition comprising more than 70% (w/w) of protein and less than 8% (w/w) of fat, said composition being in a solid form having a particle size of smaller than 1000 microns, wherein said composition comprises a denatured enzyme and said enzyme is not derived from said animal source.

2. The composition of claim 1, wherein said composition is in a solid form having a particle size of smaller than 100 microns.

3. The composition of claim 1, wherein said starting material is mechanically separated chicken having an average particle size smaller than 5 mm.

4. The composition of claim 1, wherein said composition comprises amino acids having an amino acid profile that scores at least 90 Protein Digestibility Corrected Amino Acid Score (PDCAAS) compared to egg.

5. The composition of claim 1, wherein said composition comprises amino acids having an amino acid profile that scores a perfect 100 PDCAAS compared to egg.

6. The composition of claim 1, wherein said composition has a Protein Efficiency Ratio (PER) score of greater than 60 as compared to egg protein on PER tests performed on rats.

7. The composition of claim 1, wherein said composition has a PER score of greater than 80 as compared to egg protein on PER tests performed on rats.

8. The composition of claim 1, wherein said animal source is poultry.

9. The composition of claim 1, wherein said animal source is chicken.

10. The composition of claim 1, wherein said composition is prepared by a method comprising:
(a) incubating said starting material with water at a temperature between 150-200 F to form a cooked material,
(b) incubating said cooked material of step (a) with an enzyme at a temperature between about 120° F. and 140° F. for a time period between 1 and 3 hours,
(c) heating the mixture containing enzyme from step (b) to at least 180° F. for at least five minutes to fully cook the mixture and denature the enzymes and form a cooked slurry,
(d) incubating the cooked slurry of step (c) further at a temperature between about 200° F. and 300° F. under a pressure between 10 and 15 psig for a time period between 1 and 6 hours to form a fully cooked slurry,
(e) separating the fully cooked slurry of step (d) into solid and liquid fractions, and
(f) collecting said solid fraction to obtain said composition.

11. The composition of claim 1, wherein said composition is prepared by a method comprising:
(a) mixing said starting material with water at room temperature,
(b) separating solid fraction from liquid fraction after mixing step (a),
(c) incubating said solid fraction of step (b) with an enzyme at a temperature between about 120° F. and 140° F. for a time period between 1 and 3 hours,
(d) heating the mixture containing enzyme from step (c) to at least 180° F. for at least five minutes to fully cook the mixture and denature the enzymes and form a cooked slurry,
(e) separating the fully cooked slurry of step (d) into solid and liquid fractions, and
(f) collecting said solid fraction to obtain said composition.

12. A method for making a protein composition having small particle size from a starting material derived from an animal source, said method comprising:
(a) incubating said starting material with water at a temperature between 150 F-200 F to form a cooked material,
(b) incubating said cooked material of step (a) with an enzyme at a temperature between about 120° F. and 140° F. for a time period between 1 and 3 hours,
(c) heating the mixture containing enzyme from step (b) to at least 180° F. for at least five minutes to fully cook the mixture and denature the enzymes and form a cooked slurry, and
(d) incubating the cooked slurry of step (c) further at a temperature between about 200° F. and 300° F. under a pressure between 10 and 15 psig for a time period between 1 and 6 hours to form a fully cooked slurry.

13. The method of claim 12, further comprising steps (e) separating the fully cooked slurry of step (d) into solid and liquid fractions, and (f) collecting said solid fraction to obtain said composition.

14. The method of claim 13, further comprising a step of drying the solid fraction of step (f) and processing the dried solids into particle size of smaller than 500 microns.

15. The method of claim 13, further comprising a step of drying the solid fraction of step (f) and processing the dried solids into particle size of smaller than 100 microns.

16. The method of claim 13, wherein said separation step (e) is carried out by centrifugation.

17. The method of claim 12, wherein said enzyme in step (b) comprises a protease.

18. The method of claim 17, wherein said protease has a working concentration in the range of 0.1%-0.5% by weight.

19. The method of claim 12, wherein no pH adjusting agent is added during said process.

20. A method for making a protein composition having small particle size from a starting material derived from an animal source, said method comprising:
(a) mixing said starting material with water at room temperature or lower,
(b) separating solid fraction from liquid fraction after mixing step (a),
(c) incubating said solid fraction of step (b) with an enzyme at a temperature between about 120° F. and 140° F. for a time period between 1 and 3 hours, and
(d) heating the mixture containing enzyme from step (c) to at least 180° F. for at least five minutes to fully cook the mixture and denature the enzymes and form a cooked slurry.

21. The method of claim 20, further comprising steps
(e) separating the fully cooked slurry of step (d) into solid and liquid fractions, and
(f) collecting said solid fraction to obtain said composition.

22. The method of claim 21, further comprising a step of drying the solid fraction of step (f) and processing the dried solids into particle size of smaller than 100 microns.

23. A food or beverage product, comprising the composition of claim 1.

24. The food or beverage product of claim 23, wherein said food or beverage product is selected from the group consisting of protein drink, smoothies, and other nutritional beverages.

25. The composition of claim 1, wherein said composition is used as a dietary supplement or as a component of a dietary supplement.

26. The composition of claim 1, wherein said composition is used as a prebiotic supplement or as a component of a prebiotic supplement.

27. The composition of claim 1, wherein said composition is used to alter or to maintain a gut microbiome of a mammal.

28. The composition of claim 1, wherein said composition is used to achieve or maintain a balance of bacterial species in the intestinal tract of a mammal.

29. The composition of claim 1, wherein said composition is used as a component of a protein formulation to be administered to a mammal, said protein formulation serving at least one function selected from the group consisting of promoting growth of certain gut bacterium in said mammal, maintaining a specific gut microbiome, enhancing immunoresponse, modulating inflammatory response of said mammal, and combination thereof.

30. The composition of claim 1, wherein said composition is used as a component of a protein formulation to be administered to a living organism selected from the group consisting of a fish, a bird, and a domestic animal, said composition serving at least one function selected from the group consisting of promoting growth of certain gut bacterium in said organism, maintaining a specific gut microbiome, enhancing immune response, modulating inflammatory response of said organism, and combination thereof.
